(19) United States
(12) Patent Application Publication
(10) Pub. No.: US 2008/0103894 A1
(43) Pub. Date: May 1, 2008

(54) System and method for awarding and redeeming merit points for participation, competition, and performance in sports and in the arts and sciences

(76) Inventors: Gladstone Chikuang Liang, San Francisco, CA (US); Roberto Dino Galletti, Clayton, CA (US)

Correspondence Address: GLADSTONE LIANG, 970 ANZA ST., SAN FRANCISCO, CA, 94118, US

(21) Appl. No.: 11/590,236

(22) Filed: Oct. 28, 2006

(51) Int. Cl. G06Q 30/00

(52) U.S. Cl. 705/14

(57) ABSTRACT

A method and process for providing a merit-based incentive points system for amateur sports and competitive and non-competitive events wherein merit points are purchased from points administrator and distributed by event organizers and sponsors as participation and performance awards to contestants and participants. Such merit points functioning as points currency of value, can be accrued, traded, exchanged, and redeemed for scholarships, goods and services. In order to maximize points accumulation and benefits, an auxiliary support system in a form of social network of parents, relatives, friends, and boosters and supporters, in conjunction with pre-existing reward points credit cards, are recruited to sign up for reward points credit cards, thereby having the earned reward points routed to any designated points recipient. To enhance the liquidity and convertibility of two distinct points systems, and to provide a platform where points can be traded, exchanged, an electronic market exchange provides the means and apparatus to achieve such objectives. Additionally, this invention further maximizes points return by providing the means, method, and platform for points' cash value to be invested in the financial and capital markets, thereby functioning as an alternative form of financial instrument.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to generally to the field of redeemable points incentive program and specifically to a system and method of providing merit points for participation, competition, and performance in sports and in the arts and sciences.

2. Prior Art

In the prior art, to train, nurture, and develop a competitive athlete or an aspiring artist, musician, debater, requires enormous commitment in time and financial resources. Unless one has access to substantial financial means, many promising and competing youngsters often are denied the opportunity to further developing and refining their skills and to participate in serious organized and sanctioned competitions. Even sports organizations often have to resort to fund raising activities in order to provide the funding for team travel expenses. Training and equipment costs, travel expenses are substantial and often prohibitive. Since only a small percentage of serious athletes and individuals whose families could afford such luxury, an even smaller percentage of elite athletes would actually receive college athletic scholarships let along financial assistance outside the family circle. And to aspire financial rewards from professional sports poses further remoteness. To maintain amateur status as an athlete, financial rewards or awards are strictly regulated and, in some sports, prohibited. For a promising contestant or athlete there is little opportunity to earn financial rewards that could be applied to defray the enormous costs of such athletic, artistic and academic pursuits. Typically a ranked junior golfer's parents, for example, spend between $25,000 to $100,000 a year in training costs, coaching, equipment, entry fees, and travel expenses. As the pay and contracts for professional athletes and artists are getting astronomically large, the costs and entry fees for competition events are also getting to be very expensive. And parents are hard pressed to financially support their children in their chosen interest of organized competition. There is little in the way of financial help for majority of the contestants available for these youngsters and contestants. So the logic goes, if professional golfers playing the PGA tournaments make a living, shouldn't junior golfers earn their scholarships or receive some financial assistance playing junior golf tournaments? Shouldn't competing martial artists find a financial ways and means to help defray expenses so the art can be further pursued? Shouldn't there be a way allowing young athletes to earn merit points for excellence in athletic and academic endeavors without jeopardizing their amateur status as amateur athletes? Shouldn't the communal resources of parents, relatives, friends, and supporters be tapped and utilized? This comes into an important feature of this invention, a system of utilizing the infrastructure of social networking, thereby enabling a form of auxiliary financial support system by tapping the financial communal resources.

For event organizers and sanctioning bodies of sports and competition, costs for organizing and conducting tournaments, contests, and events are escalating year after year. Insurance, trophies, prizes, marketing expenses and other personnel overheads and incidental expenses constitute large expenditure. Additionally, securing sponsorships, sponsors, donations, prizes are increasing difficult to obtain and takes up considerable portion of time and expenses. And frequently, prizes that took enormous amount to time and effort to obtain are not what the contestants want or need. Furthermore, trophies, prizes, and scholarships are large expenditures but they only benefit a few top elite athletes or competitors. The rest of the competitors receive virtually nothing in return so to speak. Shouldn't there be a more cost effective and cost efficient way to provide practical and useful awards to the contestants and at the same time, reduces operational overheads?

The U.S. Figure Skating Association, realized sooner than most of the amateur sports federation or association, that to develop a top and ranked skater athlete requires a great deal of financial support. In fact, in it's own internal study, that for a top skater, $60,000 (in 2006 dollar) a year is needed. As such, it is interesting to note that U.S. Figure Skating Association doesn't prohibit the offer and acceptance of prize money in competition. But for the sports that NCAA (National Collegiate Athletic Association) sanctions, sports colleges participate, receiving financial reward for performance is strictly prohibited. However, the rules on receiving equipment from manufacturers and suppliers are strictly regulated while not prohibited.

Commercial entities are always on the lookout for ways to promote, market, advertise, and sell their products and services. Sports and event sponsorships are a big business, and sports parents, specifically, are more than willing to sacrifice for their children to realize their dreams. In the prior art, there is little in the way where commercial entities can actually actively engage the parents and their children in a common endeavor to help their youngsters while also promoting goodwill and retaining a loyal customer and potential future customer base.

In the prior art, there is no integrated system, method, and apparatus, providing motivated youngsters a way to earn their own scholarships by their own merits, and given the enormous time commitment for training, a way to earn financial assistance to defray the cost of competition. There is no system where a youngster while in training, can also learn how to manage their financial assets and take financial responsibility for their own financial future.

### BACKGROUND OF INVENTION

3. Objects and Advantages

Accordingly, this invention relates to issuing and providing merit points so that young competitors in any sports or art can earn merit points for excellence. More specifically, this invention enables amateur athletes to receive a form of financial assistance without jeopardizing their amateur status. This invention allows such merit points to be earned, accumulated anonymously, and to be redeemed at a time most appropriate for the individual, for scholarships, and for goods and services from participating sponsors and business entities.

Organizers and sponsors of events would simply purchase merit points from the issuer and administrator and provide awards in the form of merit points to the participants and winners according to event organizer's intent and, of course, the sponsors' desire. The points will be distributed in the form of claim codes—having a unique claim code for each award. There is claim code for first place winner and another one for the second place winner. Should the sponsors desire to give additional points for participation, each participant will be each given a claim code. The recipients of such points will claim those points online via internet with their membership at the merit points' issuer and administrator's server. Once the claim code is used the proper amount of points will be credited into the member's account and such claim code will no longer be valid. A sponsor may decide, for example, Burger King, that 50 merit points will be given for every visit for a given period. General Motors, in another example, may provide 500 merit points certificates with claim codes if parents visit their showrooms.

One family's effort may not generate enough meaningful and useful financial resources to help out. Another important feature of this invention utilizes the social network of parents, relatives, friends, neighbors, boosters, and supporters, by recruiting them as auxiliary merit points members, to apply for a reward point credit card and have the reward points, earned from using the credit card, forwarded and routed to any designated merit point member's reward point account. In conjunction with the reward points earned from credit card usage, the reward points can be deployed for redemption for goods and services, entry fees, or any redemption program offered by the providers within the network. These reward points may either go to the merit points' account holder or to the auxiliary member's reward point account.

U.S. Pat. No. 6,842,739 SYSTEM FOR ELECTRONIC BARTER, TRADING AND REDEEMING POINTS ACCUMULATED IN FREQUENT US REWARD PROGRAMS, issued to Richard Postrel on Jan. 11, 2005. The '739 patent provides a system and method for operating a reward points accumulation and redemption program wherein the user earns reward points from a plurality of reward points issuing entities, each with dissimilar reward points value, accumulate all points into one account with uniform reward point value. And from such single account redemption will be made from rewards consolidated. This invention does not teach, however, the account holder to participate in recruiting new and additional auxiliary members to apply for reward points credit cards. This invention '739 also does not teach the reward points earned from one credit card be forwarded for the benefit of another reward points credit card holder or another designated merit points member account or accounts. Nor does this invention teach that points be donated.

And the bartering of reward points from plurality of issuing entities of this '739 patent, forming a single account of tradable reward points with other reward points account holders, does not teach that traders come from a single reward points issuing entity, nor does it teach that two different points systems be simultaneously present and tradable across two distinct and dissimilar points systems and value.

The present invention provides that reward points issued by single designated credit card issuer or from a plurality of contracted credit card issuers, all with uniform and exact reward point value. The present invention further provides that merit points are issued and administered not by a credit card issuing entity. Each merit point is distinct from reward point. Merit points are merit based and are generally earned by participation in events of competition and awarded by performance or rewarded by promotion or gift or donation. There is no purchase involved with merit points. The auxiliary member reward points are entirely earned by usage of the reward points credit card.

To facilitate a more efficient deployment of merit points and robust usage of reward points amongst all the members and users, the present invention provides a market exchange the forum and platform to buy, sell, trade, donate, and exchange between these two distinct systems of points. Under the present art, one merit point member might need 4000 reward points for a plane ticket in exchange for 1000 merit points. Another might need 1000 merit points to pay for golf entry fee exchanging for 10000 reward points. Still another might simply donate merit points for more deserving peers, or give away reward points to those in need. While each merit point and each reward point has a certain established cash value, the actual value is contingent upon the offer and acceptance between a buyer and a seller in a free and open market exchange.

The merit points and reward points each has certain intrinsic cash value. If cash value is inherent in the points, the present invention contents that unredeemed points dormant in accounts are just as good as cash sitting in the bank drawing no interest. Hence the present art provides the platform for opportunities where points, as form of or as investment return in points, depending on how they are invested in the financial and capital markets.

When comes time for redemption, the present invention provides not only various choices such as goods and services offered by approved providers linked to their own websites or offered on points administrator's own website, but also options where the user may decide if the points are to be banked and managed until redemption. The points can accumulate indefinitely and redeem at any time. Over time, the points add up to considerable amount of value as the points continue to grow. Points may be used for paying school tuition, for house down payment, vacation, wedding, or just about anything where there is a willing goods and services provider approved by the points issuer and administrator.

For the buyers of merit points, this present invention provides a readily tradable commodity in the form of points, allowing the user of the merit points or reward points to redeem for goods and services that they need and seek, thereby eliminating the waste when the same items, such as hats used as tee prizes in junior golf tournaments, are given more than once too often. Functioning like a gift card, the popularity and acceptance lie in the ability by the points account user to acquire exactly what is needed. Furthermore, the buyer may additionally award more points for certain promotional activities for specific consumer behavior. T-Mobile may, during its promotion for new customer, provide 1000 reward points to the parent and additional 2000 merit points for the parent's child or children with merit points membership account. Business entities with their own merit points and reward points accounts with the points issuer and provider, can administer and manage their own points issuing activities. Gap may order additional 10,000,000 reward points online from its own computer monitor in addition to the normal reward points for the usage of the credit card, and offer to auxiliary reward points members for purchases during a specific time frame, and order 20,000,000 merit points for their children or designated recipients with merit points membership accounts. Gap has the complete freedom as a marketer and retailer to design the manner and number in how it wishes to distribute the merit points and reward points in conjunction with its targeted marketing campaigns.

For the likes of Merrill Lynch or Bank of America, each may offer programs to entice members to part with the points and convert into cash and invest in the financial market or simply bank cash in interest bearing accounts. To retain customers' loyalty and to promote their products to a hosts of young future regular customers, they may offer better services and terms than is normally offered to the public.

For the points issuer, provider, and administrator, it has a fiduciary responsibility in not only administering the merit points and reward points issuing function, the invention requires that it maintains a data processing facility or contracted for such facility in order to track, store, retrieve, and process all pertinent information, activities, and financial clearings and settlements. It has an important function as the banker, in a sense, to each and every point that is issued and spoken for. The invention requires that the points administrator manages professionally the fund which backs the points and provides payment with acceptable consideration in a timely manner when points are redeemed and submitted for payment.

Accordingly, besides the objects and advantages of the invention described in the above, several objects and advantages of the present invention are:
(a) to provide a platform and means with which merit points can be awarded for participation and performance in events of competition;
(b) to provide the means and apparatus where organizers and sponsors of events buy merit points as award prizes;
(c) to provide redemption options and programs where merit points earned and awarded can be redeemed for goods and services, and monetary or financial instruments of value;
(d) to provide the means and apparatus utilizing a social network of parents, friends, relatives, boosters, and supporters, using the reward points credit cards as an auxiliary means of providing additional means of financial resources. Such reward points are to be forwarded for the beneficiary of designated merit points members;
(e) to provide merit points and reward points a platform and apparatus for an market exchange to buy, sell, trade, donate, and exchange points of two different and distinct nature; and
(f) to provide a method and process where points can function as a form of financial instrument thereby allowing the points to be invested in financial and capital markets.

Further objects and advantages will become apparent from a consideration of the ensuing description and drawings.

### SUMMARY

In accordance with the present invention, this invention comprises a system and method for awarding and redeeming merit points for meritorious participation and performance in events of competition. Such merit points are purchased by event organizers and sponsors and are redeemable for scholarships, prize, good, and services, or monetary and financial instruments. Additional benefits may be derived for the merit points account holder from auxiliary reward points credit card holders whom the merit points account holder recruits and signs up. Such reward points from credit cards are to be donated and routed to designated merit points account holder. To provide additional points acquisition and accumulation, funds backing the points are to be invested in financial market or financial instruments so the real gain provides additional financial benefits to the merit points members in cash or in points. To further provide efficiency, liquidity, and convertability in the redemption and usage of merit and reward points, a market exchange of points enabling the buying, selling, trading, exchanging, and donating of points between and across two distinct points systems to interact and function.

### DRAWINGS—FIGURES

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings, closely related figures may have the same number but different alphabetic suffixes.

FIG. 1 shows a flow chart of the process and method by which merit points are sold, distributed and claimed.

FIG. 2 shows a flow chart of the process of merit point membership application.

FIG. 3 shows a flow chart of the process from event registration to claiming merit points from event organizers and sponsors.

FIG. 4 shows a flow chart of the process by which auxiliary members are recruited for the purpose of being the recipient of auxiliary members' credit card reward points.

FIG. 5 shows a flow chart and schematic decision process and method in determining how the reward points are to be donated by auxiliary members with credit card reward points.

FIG. 6 shows the flow chart of redemption process.

FIG. 7 shows the schematic block view of the points market exchange and the process and method by which merit points and reward points are to be traded, bought, sold, exchanged, and donated in the market exchange.

FIG. 8 shows the flow chart of the process of points conversion to cash value and financial advisor or provider selection process.

FIG. 9 shows the perspective of the invention with its major operational and functional components.

### DETAILED DESCRIPTION OF THE PREFERRED EMBODIMENT

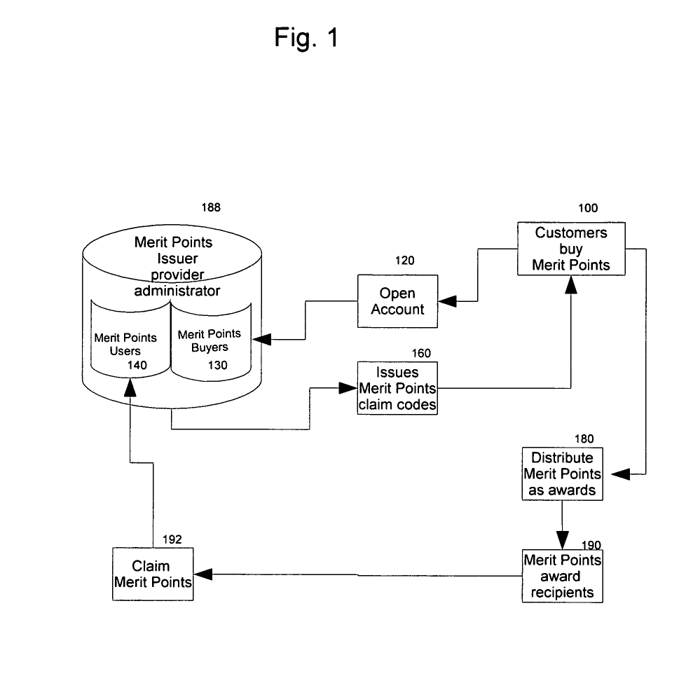

To accomplish an important function of the invention, turning first to FIG. 1, there is shown customers such as event organizers or sponsors 100 would first open an account via the internet, accessing the website of merit points issuer, provider, and administrator 188. The website and its software will guide the customers to open an account as merit points buyer and provide the tools to make the purchase of merit points as required 130. Once the purchase is made, either by credit card or other means of online payment, and assuming each merit point costs 10 cents, the purchase of $4000 will result in 40,000 merit points. Assuming further that the event organizers wish to award 100 points to each participant with the first place winner award receiving 20000 merit point, second place award 10000 merit points, and third place 5000. The balance of the merit points are distributed with 100 merit points each to each of the 50 participants. A series of claim codes will be generated from points administrator's computer. There are 53 claim codes. One for 20,000 merit points, one for 10,000 merit points, another for 5000 merit points, and there are 50 claim codes for 100 merit points each 160. The claim code certificates will be presented to the awardees 190 who will then log onto merit points server 188 and claim the merit points with the claim code. Once the claim code is used and merit points claimed 192, the proper merit points will be included or added to the claimant's merit points' account 140. As claim codes are claimed and processed, the merit points server will make the proper clearing and settlement reflecting the transactions and adjusting the balances of accounts 130, 140.

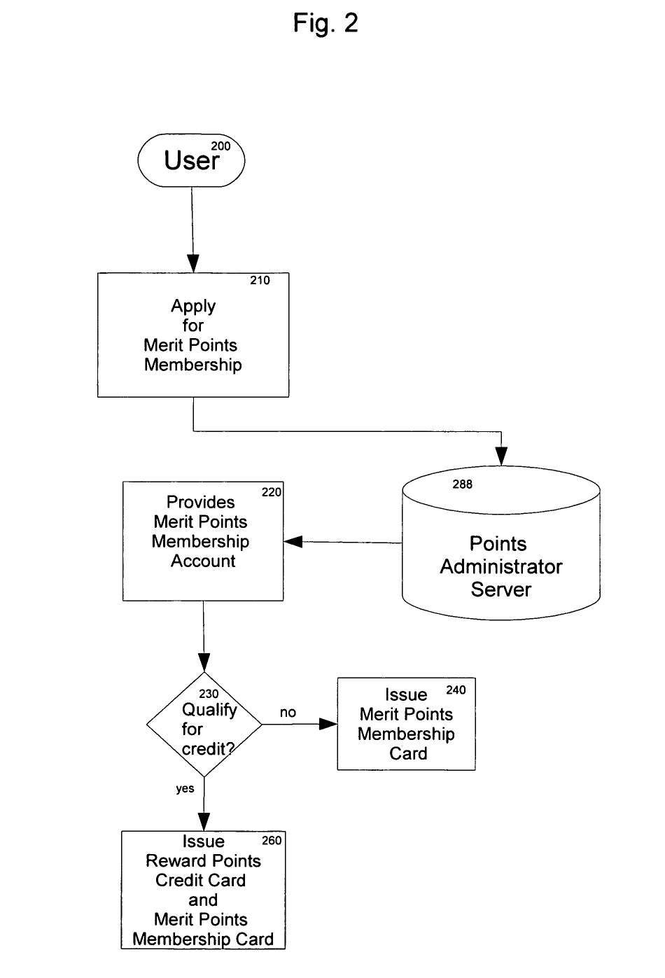

Turning now to FIG. 2, the merit points membership is opened to all applicants via the internet with an online application process that is typical of the existing process and protocol 210. The points administrator's server will process the application request and provides the applicant a membership account 220. The system will further provide the option of determining if the applicant alone is qualified for reward points credit card 230. This is true if the applicant is an adult, as with many adult Olympians. The reward points credit card is offered by the merit points administrator with its own co-branded reward points credit card in cooperation with a selected credit card issuing entity or with a plurality of contracted credit card issuers. This is a means to further the benefits to merit points account holders, deriving from reward points credit card in addition to merit points. As with many adults with Olympic aspirations, who have regular jobs, qualifying for credit card is not a problem. But the advantage of possessing this co-branded reward points credit card, as co-issued by the merit points administrator, is that the reward points are negotiated with the credit card issuing financial entity or entities at a better terms than are available to regular credit card customers. Once approved by the credit card issuing financial entity, applicant will be issued a reward points credit card and provided with merit points membership card, or membership identification card 260. If not qualified for credit card, then a merit points membership card will be issued 240.

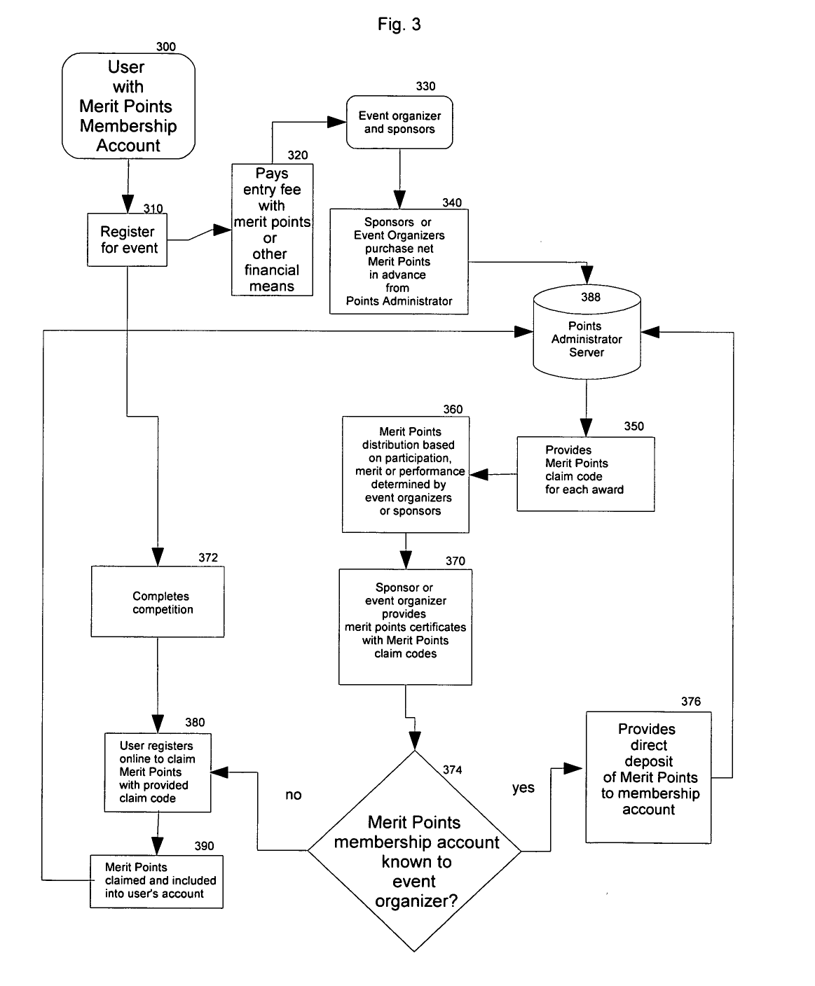

Once becoming a member of merit points award system 300, shown in FIG. 3, the member may register and enter a chosen event 310, whether it's for a sports competition or music competition, or any event where awards are given for excellence in performance, the applicant may elect to pay the entry fee 320 either with accumulated merit points or reward points or a combination of both, or in currency or consideration accepted by the event organizer 330 in accordance with the present invention. Based on the number of applicants and the number of merit points and reward points received for payment of entry fee, the event sponsor can determine the net merit points and reward points needed to purchase from points administrator in order to provide the merit points and/or reward points to be given as award for participation and placement in competition 340. Event organizer has the option of accepting both merit points and reward points as payment for entry fee, also true is the option to decide to award only merit points, or only reward points, or both. Once the event organizer determines the kind and amount of points needed to purchase, the order is then placed with the points administrator via internet after logging into the server 388. The server with its order taking software will require detailed specifications. After payment is made online, the points administrator's server will then generate, as specified by the buyer, merit points and/or reward points claim codes 350. The specific claim codes as ordered by the buyer can be printed on award certificates 370. An alternative process of the preferred embodiment allows also that the points customer to purchase a lump sum of points, say 1,000,000 points, or $100,000 worth of points, and manages its account and generates the claim codes for distribution as it sees fit, or until the points are depleted. As with any self-managing account, the points can be replenished any time by the customer. For example, Hertz may decide to award merit points for auxiliary members for renting its cars. With one universal claim code, say 500 merit points per rental and 1% of charged amount of reward points credit card, Hertz may order a lump sum of points of both merit and reward points, and have the points draw down with each rental completion. The points issuer may setup an automatic points issuing, billing and payment system as would fit the needs of the customer. At the conclusion of the event 372, and receiving the claim code or codes (if more than one award) 370, the competitor will log online and claim the points as awarded 380 and such points claimed will be included into the claimant's account 390 in points administrator's server. If the contestant preferred, by providing the event organizer member's account number 374 at the outset of the event, points earned associated with his particular contestant will be deposited directly into member's account 376 from the event organizer's monitor. This is a convenient feature when access to internet is not readily available or when the contestant is too busy training, competing, and traveling.

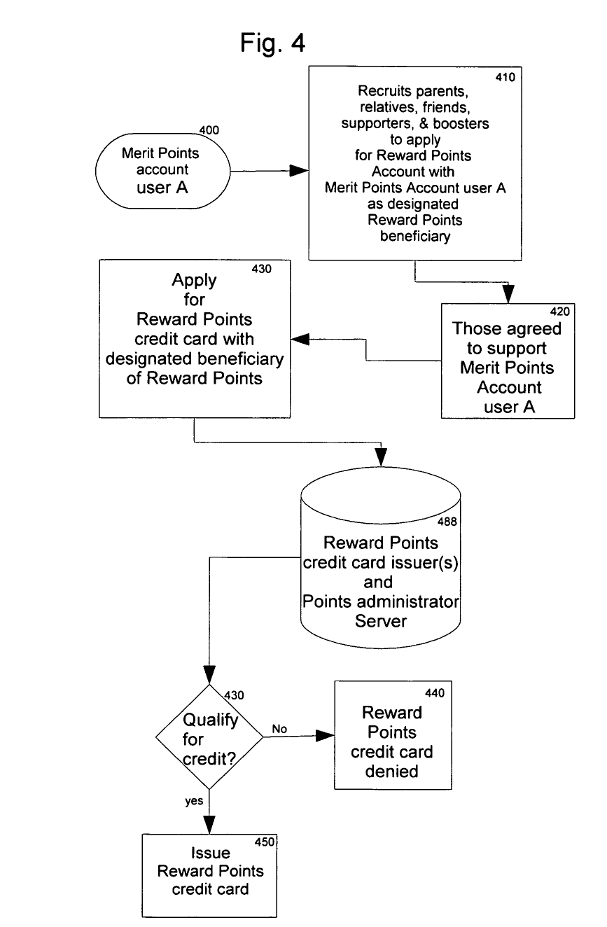

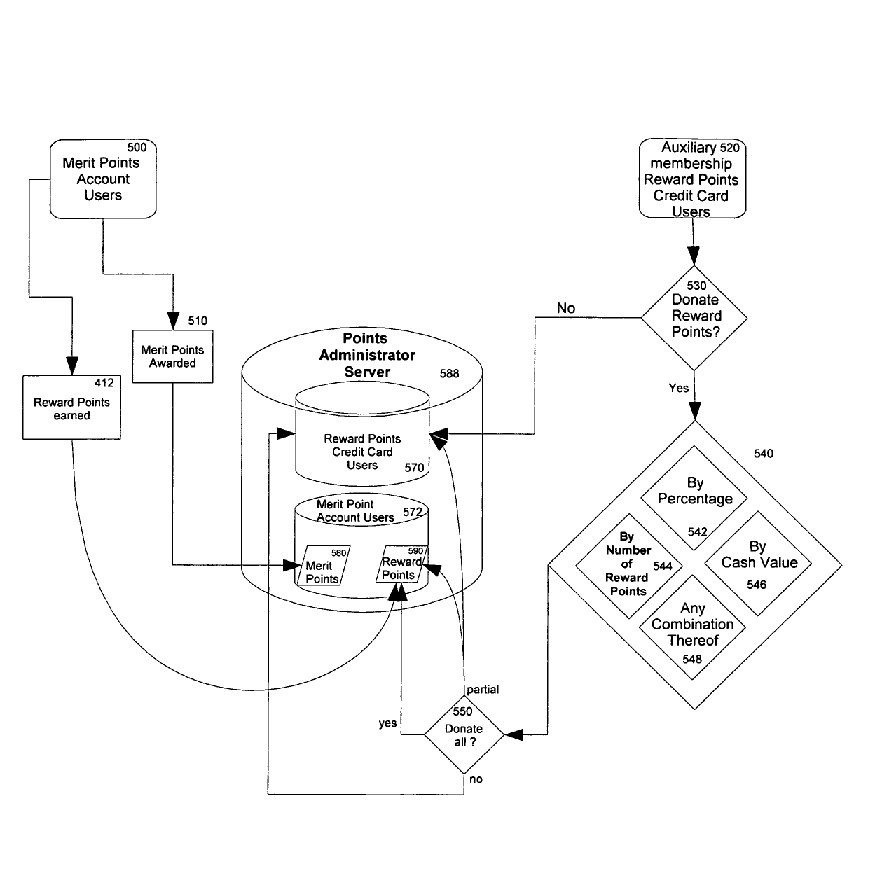

In accordance with an important feature of the present invention, there is shown in FIG. 4 the method and process of merit points member recruiting auxiliary members 410 for reward points credit cards and have them consented to designate and donate their reward points earned to the recruiting member 420. In a preferred embodiment, a village of supporters is developed and recruited to help any individual or group or entity. By designating part or all reward points received by the supporters and route them to the designated recipients, the beneficiaries of these donated reward points will see his/her reward points increase far more rapidly. It is a form of social networking, of marshaling the communal financial resources that would enable the aspiring athlete or artist the means to receive financial help and to continue training, developing, and competing. Grandma and grandpa would certainly love to help out. Friends and other relatives would love to be a part of this system of providing useful and practical help without disruption or inconvenience in their spending habits. The application for this unique reward points credit card will include designating a certain merit points member as the exclusive reward points recipient or beneficiary 430. Once the reward points credit card is approved and issued 450, the auxiliary member may decide to manage how he or she wishes to donate 530 the reward points earned as shown in FIG. 5. The auxiliary member can control in a number of ways how the reward points are to be distributed or donated. Auxiliary member can, for example, decide by percentage 542, say 50% of the reward points, or 20% to merit points member A and 30% to merit points member B, and keep the balance. The auxiliary member can further manage by donating based on cash value 546, say a limit of $1000. Once the limit of $1000 in cash value of reward points has been reached, reward points will no longer be forwarded but remain with the auxiliary member for his or her own use. Furthermore, auxiliary member may decide to donate and transfer by the number of points, say 50,000 reward points 544. Or the auxiliary member may elect to donate 50% of reward points with a limit of 100,000 or not to exceed $10,000 in cash value 548. The reward points donated to designated merit points recipient(s) will be added into their respective reward points account 590. The balance that the auxiliary member doesn't want to donate will be included and reflected in his or her auxiliary member reward points account 570. For merit points account user 500, the merit points earned from competition and awards 510 will remain in their merit points account 580. As with all merit points members, each has one merit points account 510 for merit points awarded from competition 510, and a reward points account 580 for reward points donated or earned if qualified for reward points credit card 512.

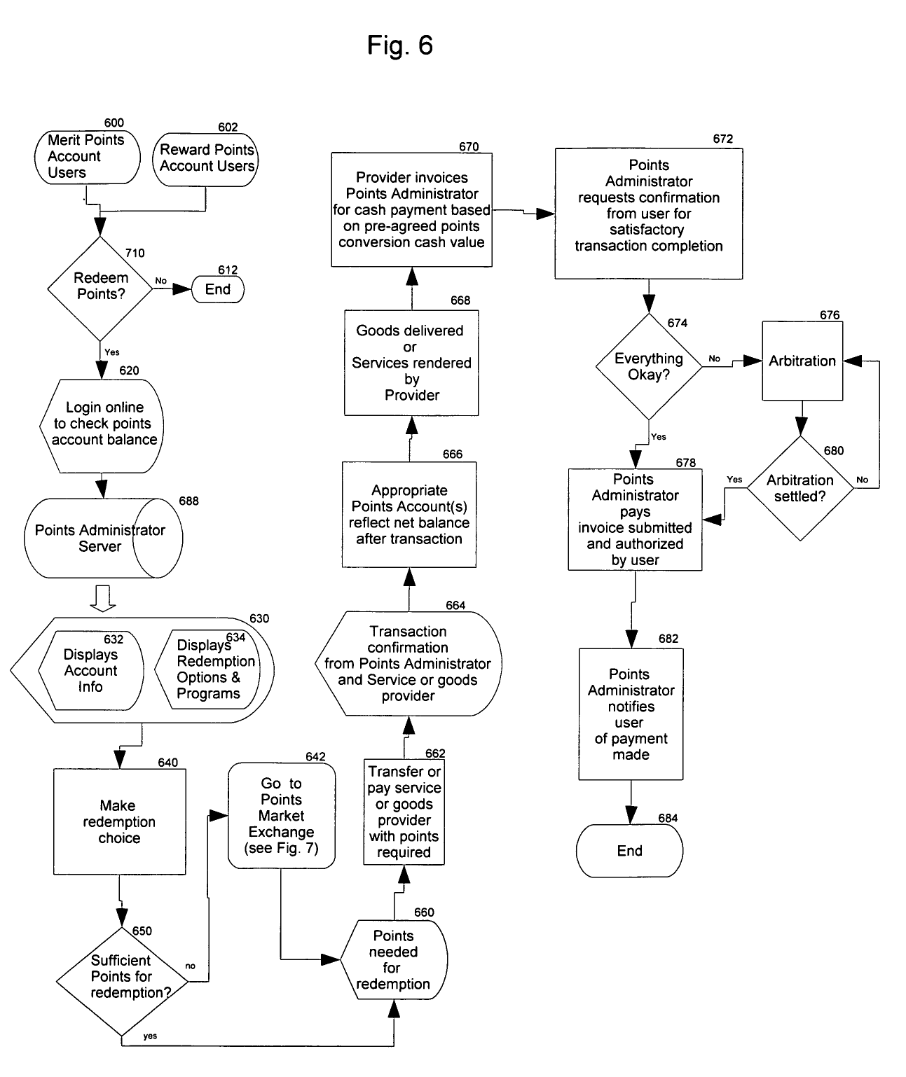

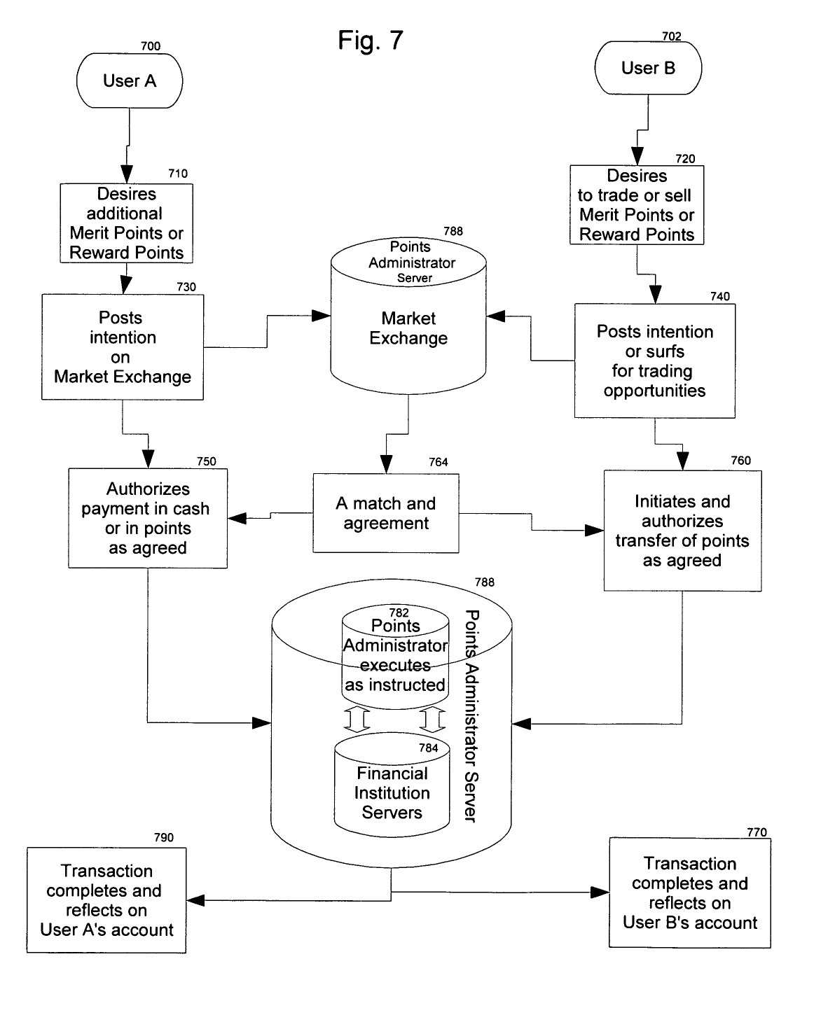

As an integrated component of the preferred embodiment, and to accomplish an important feature of the present invention, there is shown in FIG. 6 the method and process of redemption for goods and services. The primary intent of this invention is to provide useful and practical means to help youngsters or those in long training for a devoted art, to help underwrite the costs of training and the costs of competing, which include traveling expenses. All of these endeavors are very costly and expensive. And hence the redemption programs and options, where merit points earned and reward points donated, must be put to good use. And thus the redemption options and programs of goods and services must be carefully chosen. Merit points members with merit points accounts only 600, or with both merit and reward points accounts, and auxiliary members with only reward points accounts 602, decide to redeem points 610 by logging online to check their points account balance 620 on the points administrator's server 688. The server 630 will display, on the monitor, account information 632 and will also display the various redemption options and programs 634. The redeemer will make a choice 640 and such choice will require certain amount of points, either merit points, reward points or a combination of both 650. If the amount of points are insufficient the redeemer will elect to go 642 to the points market exchange as shown in FIG. 7 for the needed points. Once the points needed are sufficient for redemption 660, the redemption request is made and the system will pay for the item(s) with points needed for the transaction. If not successful in obtaining needed points for redemption, the system, with its built-in software, will inform the redeemer, given the points the redeemer has, how much cash the redeemer must forward in order for the desired item to be obtained. The redeemer may pay the difference using credit card or by Paypal or any of the existing electronic payment system accepted by points administrator, or transfer fund from the cash account with merit points administrator that is linked with the approved or designated financial institution. Once full consideration is affirmed, the transaction is confirmed by the provider(s) of goods and services, and from points administrator 664. The appropriate points account and/or cash account will reflect the transaction 666. Upon the acceptance of delivery or rendering of services by the provider(s) 668, electronic invoice(s) will be submitted by the provider(s) to points administrator for payment in cash based on pre-established points to cash conversion rate or based on contracted conversion rate or simply net cash price 670. Before making payment on behalf of the points member, points administrator will request confirmation 672 by email if member is satisfied with the product or service. If there is a problem with the service or product, payment will not be made and the case will rest with the result of arbitration between member and the provider 676. When all issues are resolved and redeemer is satisfied with the service and product, the redeemer authorizes the payment and the points administrator will do so as instructed 678. Points administrator then notifies the redeemer of payment made with a payment confirmation 682.

To carry out the invention of maximizing reward points and merit points accumulation and usage and deployment, as well as to maximize the liquidity and convertibility of points, a trading platform, in the form of points market exchange, is provided. While the trading of stocks and bonds and commodities in a market exchange is nothing new, but to include this market exchange mechanism as an integrated component of this invention in conjunction with all the other operational elements and functional components, is an important feature of this invention. Another important feature of this invention with regard to U.S. Pat. No. 6,842,739, as mentioned previously, this market exchange is a trading platform for and between two distinct points systems, namely, merit points system and reward points system, and two dissimilar points value. Whereas the '739 patent requires reward points from plurality of issuing entities be converted and consolidated into one reward points account with equal point value for the general purpose of providing an uniform point value for redemption. The '739 patent involves no market exchange platform and it involves mainly between all the points issuing entities and the individual. Thus, in the present embodiment, the points market exchange, as shown in FIG. 7, involves the trading, exchanging, buying, and selling of points between individuals and only between individual merit points members and auxiliary reward points members and within the membership environment 788. The points administrator's added function in a market exchange requires that it also provides clearing and settlement services to its members. By posting the need for additional merit or reward points 730 on the market exchange network 788 by user A 700, and with User B 702 with desire to trade or sell 720 and posting his or her intention or surfing on the market exchange network 788 for trading opportunities 740. After locating a match and after some negotiations and bargaining, an agreement is made 764. As per agreement, User B will initiate and authorize the transfer of points 760 as User B will authorizes the payment in points or in other accepted and agreed form of consideration 750. Points administrator server will note such authorizations and requests and will execute as instructed 782. If payment of cash or fund transfer is involved 784, points administrator will provide the clearing and settlement functions as required of a market exchange administrator 788. Once the clearing is done and accounts settled, the affected accounts of User A 790 and User B 770 will reflect the new transaction.

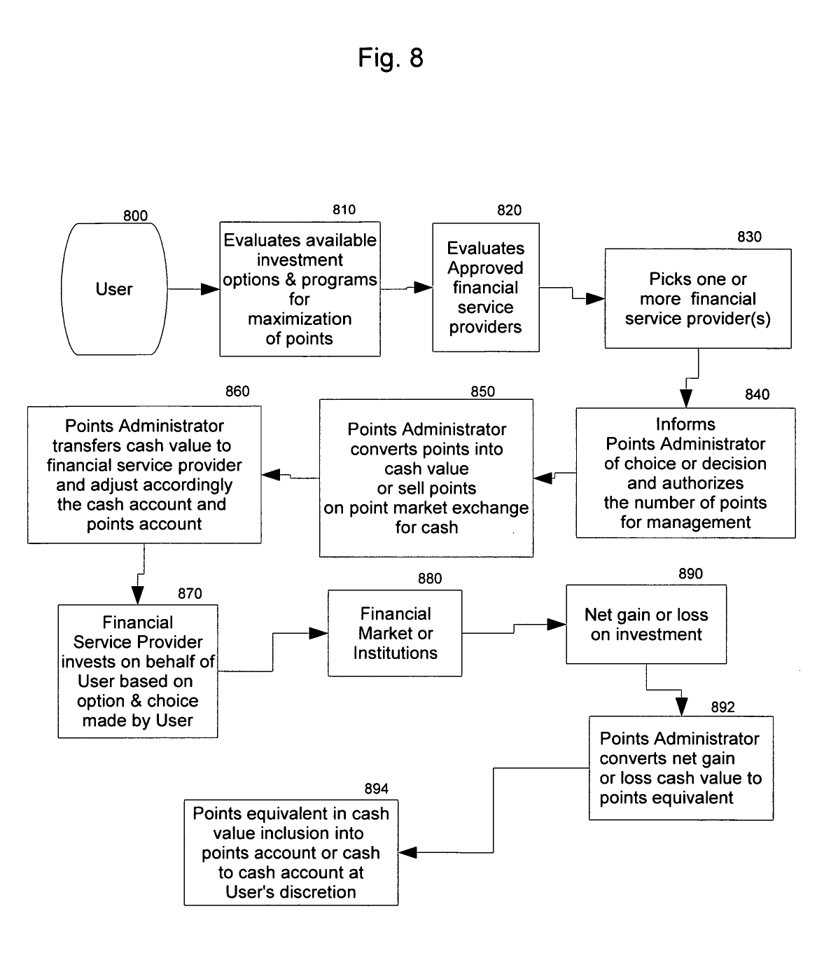

Another very important function of the invention begs the question; what to do with unredeemed points dormant and undeployed? Unredeemed points are cash dormant and draw no interest, to say the least. If points have cash value, and that points are backed by cash, then points should be used to grow more points as cash in a interest bearing account will grow more cash. As such, this invention introduces the idea of interest bearing points account, points as a derivative of cash, or, more precisely, investment-grade points. In accordance to a very important feature of the present invention, there is shown in FIG. 8 how points, either reward points or merit points, so long as each point has cash value, can be made to function as a financial instrument. Reward points and merit points account holders 800 may log on via the internet onto the points administrator's website and evaluate investment options and programs offered for maximization of points 810. From a plurality of approved financial services providers 820, one or more of the financial service providers may be picked 830. Points account holder will determine how many points are to be invested and with whom. As an example of illustration, 50,000 merit points to Merrill Lynch for stocks, and 100,000 reward points to Bank of America for 4% interest bearing account. Points administrator will be notified of the instructions, and authorization will be given 840. The Points administrator will convert the points as authorized into cash 850 and transfer such fund to the financial advisors or financial institutions as required and the points accounts—reward and merit—will adjust to reflect the reduction in points and the new investment accounts 860. If more advantageous, merit points can be sold on the points market exchange for cash 850. The financial service providers chosen will, based on points account holder's decision, invest on behalf of the points account holder 870 in financial or capital markets or institutions 880. And the resulting net gain or loss on investment 890 may be reconvert 892 to points if that is more advantageous to do so, or remain in its original investment accounts such as cash account or stock investment account 894.

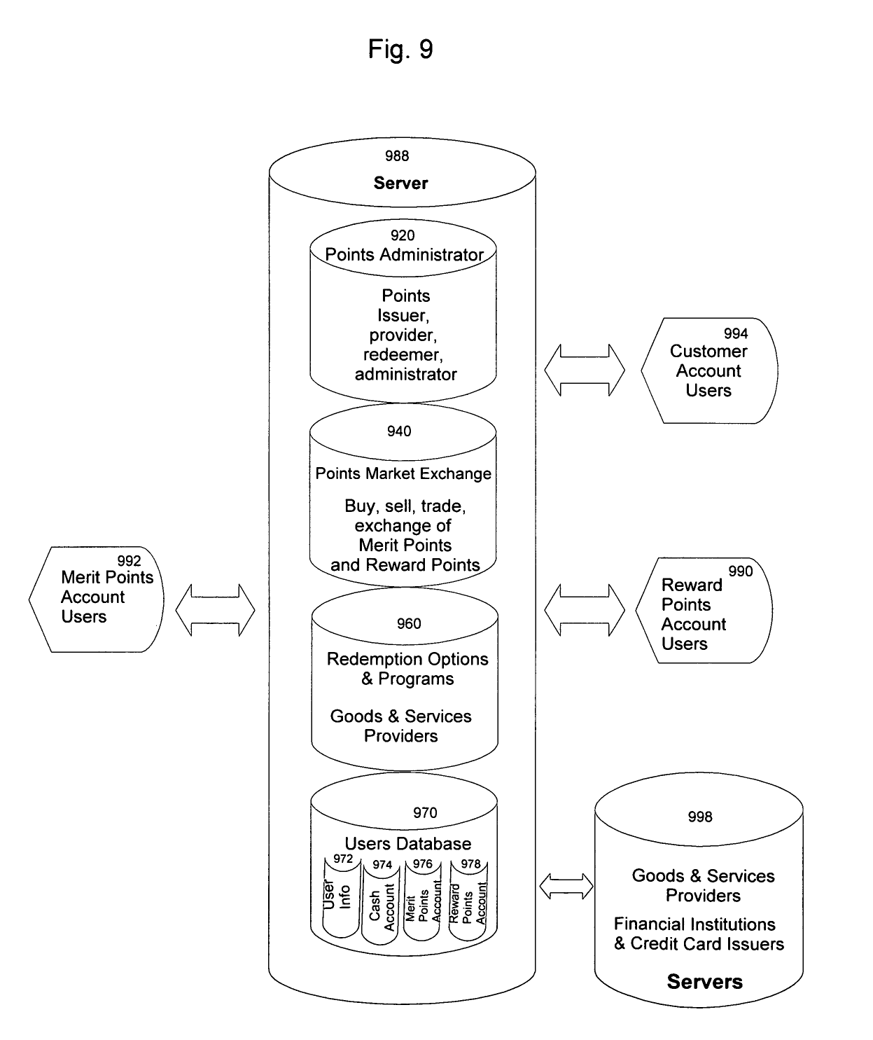

In carrying out the present invention, the preferred embodiment consists of four components encompassing the infrastructure of an integrated and interconnected system of redeemable merit-based points as well as reward points as shown in FIG. 9. This integrated system 988 includes:
(a) points administrator 920, issuer, provider, redeemer, and administrator of points as well as functioning as market exchange clearinghouse and settlement;
(b) points market exchange 940, where points are traded, exchanged, bought and sold amongst members 990, 992 and customers 994;
(c) redemption options and programs associated with goods and services providers 960; and
(d) customer and user account database 970.

The system of this invention consists of five active components of participants:
(a) points administrator 920;
(b) merit points account holders 992;
(c) reward points account holders 990;
(d) customer—points buyers—account holders 994; and
(e) goods and services providers, including financial institutions and credit card issuer(s) 960.

Merit points account user 992 earned merit points from competition and performance in competition, while reward points account user 990 earned reward points from the usage of credit cards. Customer account users 994 are the buyers and givers of either or both merit and reward points. Credit card issuer(s) 998, as co-branded reward points issuer(s) providing reward points or cash rebates as contracted with the points administrator 960. For goods and service providers 998, whose goods and services are redeemable with either or both merit or reward points as contracted with points administrator 920.

What is claimed is:

1. A method for a redeemable merit-based points system for youth and amateur sports or any competitive or non-competitive event and a method for acquisition of additional benefits in conjunction with reward points based credit cards comprising:
(a) providing merit points for purchased by customer in the amount desired to be distributed or awarded;
(b) providing said merit points purchased to be distributed in, but not limited to, printed or electronic form via the internet, or in any form or format deemed appropriate;
(c) providing a website and all computer data processing means for processing, administering, storing, and tracking all pertinent data and information regarding merit points purchased and to whom said merit points are distributed;
(d) providing any recipient of said merit points with an account for depositing, managing, and tracking of award points received, traded, exchanged, and redeemed; and
(e) providing programs, items and providers of goods and services for said merit points redemption.

2. A method of providing additional benefits to said merit points recipients utilizing a form of social networking infrastructure in conjunction with reward points credit cards, comprising:
(a) recruiting and signing up of eligible reward points credit card users willing to transfer and donate reward points earned for the benefit of any said designated merit points account user as well as reward points account user;
(b) providing any said reward points credit card user with an account for depositing, managing, and tracking of reward points received, traded, exchanged, bought, sold, and redeemed;
(c) providing a website all computer data processing means for processing, administering, storing, and tracking all pertinent data, information, and transactions regarding reward points credit card users' accounts; and
(d) providing programs, items and providers of goods and services for said reward points redemption.

3. A method, process, platform, and apparatus of an electronic market exchange wherein said reward points and said merit points account users, may, for the purpose of transferring, donating, exchanging, trading, buying, and selling two distinct points systems of dissimilar point values: merit points and reward points, comprising:
(a) providing a website and all computer data processing means, programs, and apparatus, for processing, administering, managing, inputting, storing, and tracking of all exchange transactions;
(b) providing rules and regulations of exchange transactions;
(c) providing exchange clearinghouse function;
(d) providing exchange settlement function;
(e) providing said merit points and said reward points redemption cash values;
(f) providing reward points and merit points point-for-point rate of exchange as set by said point market exchange.

4. A method, process, and apparatus of growing more points, comprising:
(a) investing the cash value of said points in financial markets;
(b) providing additional points earned from said investment the equivalent cash value in points;
(c) providing financial service providers as financial advisors to help said merit points and said reward points accounts users maximize points return; and
(d) providing a website and all computer data processing means, programs, and apparatus, for processing, administering, managing, inputting, storing, and tracking of said investment in cash value and in equivalent value in points.
